(19) United States
(12) Patent Application Publication
(10) Pub. No.: US 2006/0064482 A1
(43) Pub. Date: Mar. 23, 2006

(54) System and method for caching data and filtering data requests in a client application

(76) Inventor: Chad A. Nybo, Bozeman, MT (US)

Correspondence Address: BLACKWELL SANDERS PEPER MARTIN LLP, 4801 Main Street, Suite 1000, KANSAS CITY, MO, 64112, US

(21) Appl. No.: 10/946,392

(22) Filed: Sep. 21, 2004

(51) Int. Cl. G06F 15/173

(52) U.S. Cl. 709/224

(57) ABSTRACT

A system and method for caching data in a client application and using the cached data to filter data requests from the client application. After a client application requests and receives data from a server, at least a portion of the data is cached. When the client application makes subsequent requests for data from a server, the requests are filtered to determine if the requested data corresponds with cached data. If the data corresponds, the data is retrieved from the cache and returned to the client application. If the data does not correspond, the data is retrieved from the server and returned to the client application. Additionally, cached data may be archived when a client application closes so that the cache may be rebuilt without retrieving data from the server..

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates to client/server computer operating environments. More particularly, the present invention relates to a method, system, and computer-readable medium for caching data from a server in a client application and using the cached data to filter data requests from the client application. Additionally, the present invention relates to a method, system, and computer-readable medium for archiving the cached data and rebuilding the cache from the archived data.

### BACKGROUND OF THE INVENTION

Client/server networks are an approach to distributed computing that have gained very widespread popularity. Generally, a client/server network is a network architecture in which each component on a network can be either a client or server. Servers are components within a network that are dedicated to managing resources. Clients are components, such as personal computers or workstations, on which a user may run an application. Clients may rely on servers within the network for resources by making requests to the servers for the resources. In other words, clients may request data or services from a server, and that server responds to the request by returning the requested data or performing the requested services. Examples of client/server applications on the Internet include: (1) email clients/servers; (2) FTP (File transfer) clients/servers; and (3) web browsers/servers.

Although the client/server environment has proven to be an effective means for network computing, the process of sending requests and data back and forth between a server and client is often inefficient when there are redundant requests of data. A discussion of a web browser/server operation illustrates how the process works and how it may be inefficient. In a traditional web browser and web server operating environment, a browser user will initiate a session by entering the URL (uniform resource locator) of a particular web page. The web browser then requests the web page from a web server. The request travels through the network to a remotely located web server, which responds to the request by sending a stream of content representing the web page back to the requesting web browser. The web browser receives this stream of content, interprets the data, and displays the requested web page. Typically, the web page will have links to other web pages. If a user selects a link to a second web page, the same process is repeated. The browser requests the second web page from the web server, which sends a stream of content back to the browser for interpretation and display.

Often, the second web page will have some content that is similar to content in the first web page. For example, both web pages may contain the same images. Therefore, in the traditional operation, the process of requesting and acquiring the redundant content for the second page is unnecessary because the data already resides in the browser.

Therefore, the prior art method for obtaining content from a server for a client application is inefficient in a number of ways. First, data that is common among a number of server requests is stored in separate representations within the client application. As such, the process inefficiently takes up resources within the client application. Next, the prior art process requires separate requests to the server for redundant data, slowing the process for obtaining the data. Finally, the redundant requests increase the load on the server.

### SUMMARY OF THE INVENTION

The present invention solves at least the above problems by providing a method, system, and computer-readable medium for caching data from a server and using the cached data to filter data requests from a client application. Generally, a client application user will request data from a server. This request will be filtered to determine if the requested data is stored in a cache associated with the client application. If the requested data corresponds to data in the cache, no request is sent to the server. Instead, the data is retrieved from the cache and sent to the client application. Alternatively, if the requested data does not correspond to data in the cache, the request will be sent to the server, which will return the requested data to the client application.

Data may be added to a cache in a number of ways. For exemplary purposes, one way in which data may be added to the cache is by a client-side request to cache data. Under this approach, a request to cache data may be included with a client application's request to retrieve data from a server. After the request is sent to the server and the data is returned to the client application, the requested data is added to the cache.

Another way data may be added to a cache is by a server-side request to cache data. Under this approach, data requested from a server and sent to a client application may contain instructions to request the client application to add the retrieved data to the cache. Additionally, the data may contain instructions to direct the client application to request other data from the server to add to the cache.

When a user exits the client application, data in the cache may be saved to an archive file so that the cache can later be rebuilt. Accordingly, when a user reenters the client application and requests data corresponding with previously requested data, the server data is checked to determine if it has been updated. If the server data has not been updated, the cache will be rebuilt from the archived data. Alternatively, if the server data has been updated, the client application will request the data and cache the data upon receipt from the server.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a flowchart of an exemplary embodiment of the present invention, carried out within the system environment of FIG. 1.

FIG. 3 is a flowchart of an exemplary embodiment of the present invention, carried out within the system environment of FIG. 1.

FIG. 4 is a flowchart of an exemplary embodiment of the present invention, carried out within the system environment of FIG. 1.

FIG. 5 is a flowchart of an exemplary embodiment of the present invention, carried out within the system environment of FIG. 1.

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and or “block” may be used herein to connote different elements of methods employed, the terms should not be interpreted as implying any particular order among or between various steps herein disclosed unless and except when the order of individual steps is explicitly described.

The present invention provides a computerized method and system for caching data from a web server in a client application and using the cached data to filter data requests from the client application. Additionally, the present invention provides a method and system for archiving the cached data and retrieving the archived data to the cache. The present invention will be described more fully with reference to the accompanying figures, in which various exemplary embodiments of the invention are shown. It will be understood and appreciated by those of ordinary skill in the art that the present invention should not be construed as limited to the illustrated embodiments. Rather, the described embodiments are merely illustrative in nature.

As one skilled in the art will appreciate, the present invention may be embodied as, among other things: a method, system, or computer-program product. Accordingly, the present invention may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media may include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

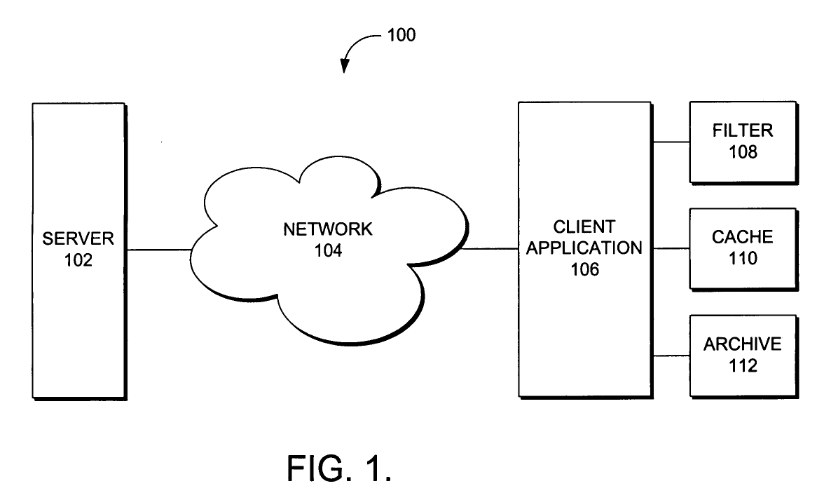

Referring to the drawings in general, and initially to FIG. 1 in particular, wherein like reference numerals identify like components in the various figures, an exemplary client/server operating environment, on which the present invention may be implemented is illustrated and designated generally as reference numeral 100. It will be understood and appreciated by those of ordinary skill in the art that the illustrated system environment 100 is merely an example of one suitable computing environment and is not intended to suggest any limitation as to the scope of use or functionality of the invention. Neither should the system environment 100 be interpreted as having any dependency or requirement relating to any single component or combination of components illustrated therein.

With continued reference to FIG. 1, the exemplary system environment 100 includes a server 102, a network 104, and a client application 106. The server 102 may operate in a computer network 104 using logical connections to one or more remote client applications, such as client application 106.

Exemplary computer network 104 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. It will be appreciated by those of ordinary skill in the art that the network connections shown are exemplary and other means of establishing a communications link between the components may be utilized.

Among other components not shown, the client application may be associated with a filter component 108, a cache component 110, and an archive component 112. Although many other internal components of the server 102 and client application 106 are not shown, those of ordinary skill in the art will appreciate that such components and their interconnection are well known. Accordingly, additional details concerning the internal construction of the server 102 and the client application 106 are not further disclosed herein.

Exemplary Operation

1. Using Cached Data to Filter Data Requests

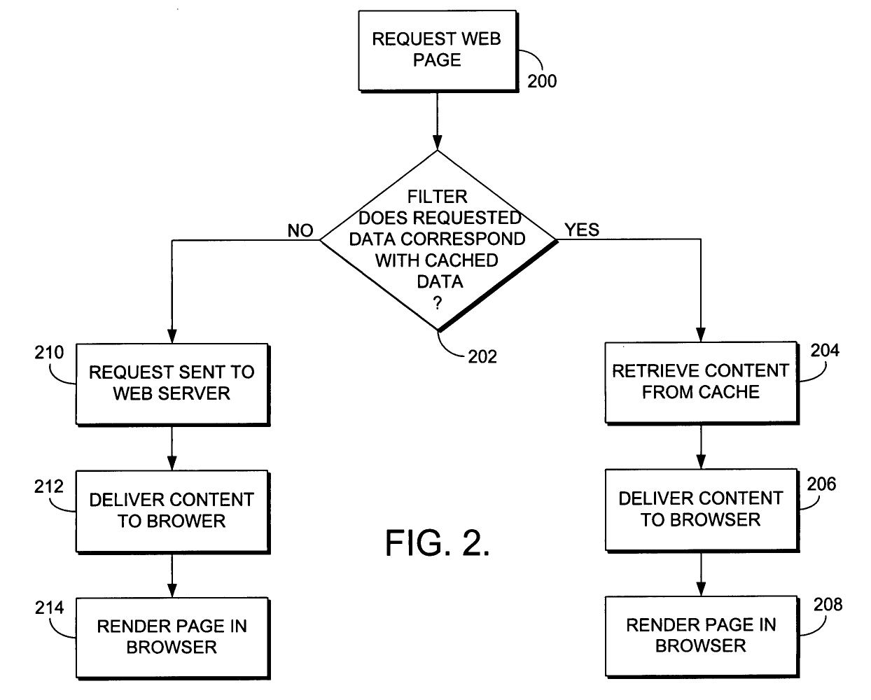

FIG. 2 shows a flowchart of an exemplary embodiment of the invention, carried out within the client/server operating environment 100 of FIG. 1, wherein the server 102 is a web server and the client application 106 is a web browser. Alternatively, the embodiment could be carried out by other client/server environments, such as with an e-mail server and e-mail client. The flowchart represents an exemplary embodiment of the filtering aspect of the invention, assuming data has already been added to the cache.

At step 200, the web browser sends a request for a web page. At step 202, the request is filtered and checked against data held in the cache to determine if the data that is being requested at that time is already available in the cache. The filter matches the URL requested to the URL of pages that are currently stored in the cache through an assorted look-up structure.

If, at step 202, the filter determines that the requested page is available in the cache, the data is retrieved from the cache at step 204. No request is sent to the web server to obtain the web page. Instead, the data retrieved from the cache is delivered to the web browser at step 206. Next, at step 208, the web page is rendered in the web browser using the data retrieved from the cache.

If, at step 202, the filter determines that the requested page is not available in the cache, the request for the web page is sent to the web server at step 210. The web server, at step 212, sends the data associated with the web page to the web browser. Next, at step 214, the web page is rendered in the web browser using the data sent by the web server.

2. Caching Data

a. Client Application Requests to Cache Data

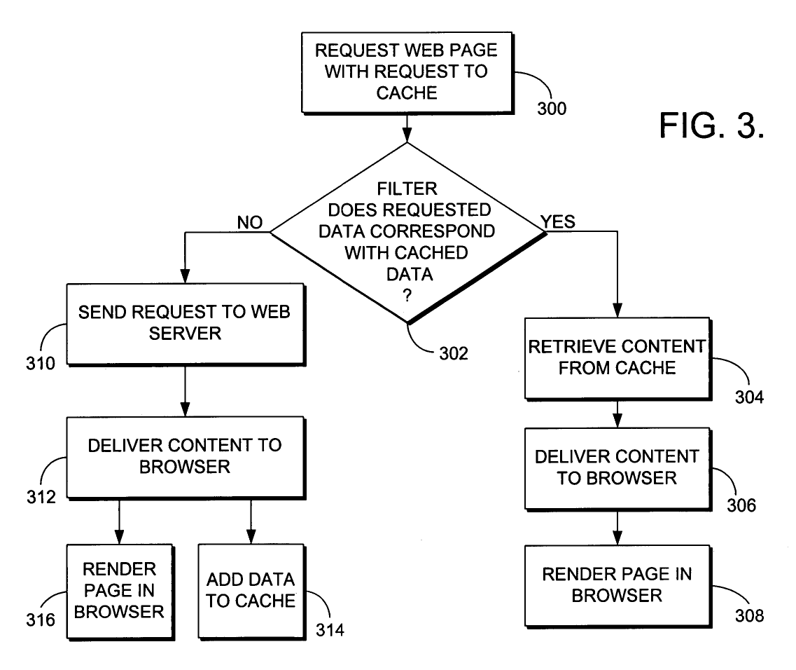

FIG. 3 shows a flowchart of an exemplary embodiment of the invention, carried out within the client/server operating environment 100 of FIG. 1, wherein the server 102 is a web server and the client application 106 is a web browser. Alternatively, the embodiment could be carried out by other client/server environments, such as an e-mail server and e-mail client. The flowchart represents an exemplary embodiment of the invention, wherein the web browser requests to cache data when it requests a web page from the web server.

At step 300, the web browser sends a request for a web page. The request includes a request to add the page to the cache. This may be accomplished by adding a “get” parameter onto the URL of the requested page that indicates that the data from this page should be added to the cache after the data is received from the web server. At step 302, the request is filtered and checked against the cache to determine if the data that is being requested at that time is already available in the cache. The filter matches the URL requested to the URL of pages that are currently stored in the cache through an assorted look-up structure.

If, at step 302, the filter determines that the requested page is available in the cache, the data is retrieved from the cache at step 304. No request is sent to the web server to obtain the web page. In addition, there is no need to cache the data associated with the web page as the data is already in the cache. Instead, the data retrieved from the cache is delivered to the web browser at step 306. Next, at step 308, the web page is rendered in the web browser using the data received from the cache.

If, at step 302, the filter determines that the requested page is not available in the cache, the request for the web page is sent to the web server at step 310. The web server, at step 312, sends the data associated with the web page to the web browser. As shown at step 314, the content is also added to the cache. Next, at step 316, the web page is rendered in the web browser using the data sent by the web server.

b. Web Page Requests to Cache Data

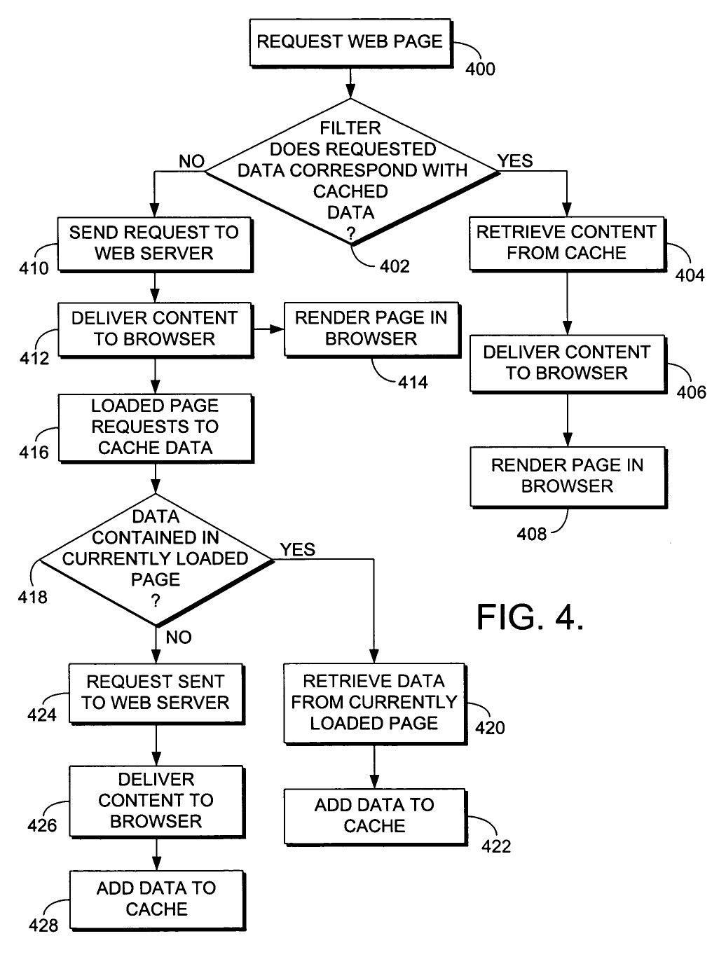

FIG. 4 shows a flowchart of an exemplary embodiment of the invention, carried out within the client/server operating environment 100 of FIG. 1, wherein the server 102 is a web server and the client application 106 is a web browser. Alternatively, the embodiment could be carried out by other client/server environments, such as an e-mail server and e-mail client. The flowchart represents an exemplary embodiment of the invention, wherein a downloaded web page requests to cache data contained either within that page or other related pages on the web server.

At step 400, the web browser sends a request for a web page. At step 402, the request is filtered and checked against the cache to determine if the data that is being requested at that time is already available in the cache. The filter matches the URL requested to the URL of pages that are currently stored in the cache through an assorted look-up structure.

If, at step 402, the filter determines that the requested page is available in the cache, the data is retrieved from the cache at step 404. No request is sent to the web server to obtain the web page. Instead, the data retrieved from the cache is delivered to the web browser at step 306. Next, at step 308, the web page is rendered in the web browser using the data received from the cache.

If, at step 402, the filter determines that the requested page is not available in the cache, the request for the web page is sent to the web server at step 410. The web server, at step 412, sends the data associated with the web page to the web browser. Next, at step 414, the web page is rendered in the web browser using the data sent by the web server.

The loaded web page may contain instructions within its scripting language to make a request to cache data. One way this may be done is to add comments into the web page. Those comment tags are not processed by the browser to be viewed, but only instruct the browser to cache certain data. This is represented at step 416, in which the currently loaded web page makes a request to cache data.

The data to be cached may be contained within the scripting language of the page. For example, the web page may instruct the browser to cache the contents of that web page. In addition, the data representing other web pages may be nested within the page, and the page may instruct the browser to cache this data as well. Alternatively, the web page may contain instructions for the browser to send a request to the web server to deliver content from other web pages and to cache this data when received. At step 418, whether the data to be cached is contained within the currently loaded page or within the web server is determined.

If, at step 418, the data to be cached is nested in the currently loaded page, the data is retrieved from the page, as shown at step 420. Then, at step 422, the data is added to the cache. Alternatively, if, at step 418, the data to be cached is not nested in the currently loaded page, a request for the data is sent to the web server at step 424. Then, at step 426, the data is sent from the web server to the web browser. At step 428, the data from the server is added to the cache.

3. Archiving Data

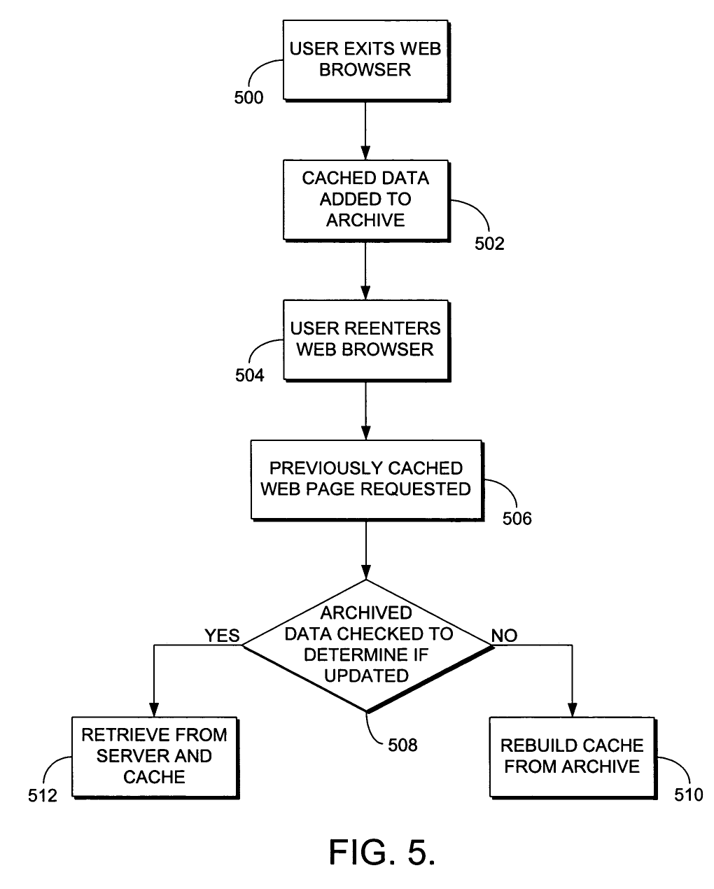

FIG. 5 shows a flowchart of an exemplary embodiment of the invention, carried out within the client/server operating environment 100 of FIG. 1, wherein the server 102 is a web server and the client application 106 is a web browser. Alternatively, the embodiment could be carried out by other client/server environments, such as an e-mail server and e-mail client. The flowchart represents an exemplary embodiment of the invention, wherein cached data is archived when a user exits the client application and subsequently rebuilt from the archive when the browser later attempts to revisit web pages.

At step 500, the user exits the web browser. As the web browser is closing, data is removed from the cache and written to an archive file, as shown at step 502. Each web page representation is written in the archive file in a specific sector so that it represents the way the memory was structured in the cache. As shown at step 504, the user may at a later time reenter the web browser. At step 506, the user wishes to navigate to a web page that was previously loaded and cache. The archived data is checked to determine if the page has been updated, as shown at step 508. If the page has not been updated, the cache is rebuilt from the archive memory structure so that the content is available again, as shown at step 510. If the page has been updated, the cache is not rebuilt from the archive memory. Instead, the page is retrieved from the web server and the cache is updated, as shown at step 512.

### CONCLUSION

As can be seen, the present invention and its equivalents are well-adapted to provide a new and useful method for caching data and using cached data to filter data requests. Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled programmer may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A method of managing prescribed data when said data includes frequently used data or a large data object, said method comprising:
receiving data from a server;
storing said data in a client application memory;
caching at least a portion of said stored data;
filtering a request for data, wherein said cached data is made available to said client application upon such requested data corresponding to said cached data; and
retrieving new data from said web server when said requested data does not correspond to said cached data.

2. A method as set forth in claim 1, further comprising:
caching at least a portion of said new data.

3. A method as set forth in claim 1, further comprising:
archiving said cached data.

4. A method as set forth in claim 3, further comprising:
retrieving said archived data as cached data.

5. A method as set forth in claim 1, wherein the client application is a web browser or an email client.

6. A method as set forth in claim 1, wherein the server is a web server or email server.

7. A method as set forth in claim 1, wherein the cached data is made available by rendering said cached data.

8. A system for managing prescribed data when said data includes frequently used data or a large data object, said system comprising:
a client application component operative to receive data from a server;
a storage component operative to store said data in a client application memory;
a caching component operative to cache at least a portion of said stored data;
a filtering component operative to filter a request for data, wherein said cached data is made available to said client application upon such requested data corresponding to said cached data;
a retrieving component operative to retrieve data from said web server when said requested data does not correspond to said cached data.

9. A system as set forth in claim 8, further comprising:
a second caching component operative to cache at least a portion of said new data.

10. A system as set forth in claim 8, further comprising:
an archiving component operative to archive said cached data.

11. A system as set forth in claim 10, further comprising:
a retrieving component for retrieving said archived data as cached data.

12. A system as set forth in claim 8, wherein the client application component is a web browser or an email client.

13. A system as set forth in claim 8, wherein the server is a web server or email server.

14. A system as set forth in claim 8, wherein the cached data is made available by rendering said cached data.

15. A computer readable medium having computer executable instructions for performing a method comprising:
receiving data from a server;
storing said data in a client application memory;
caching at least a portion of said stored data;
filtering a request for data, wherein said cached data is made available to said client application upon such requested data corresponding to said cached data; and
retrieving new data from said web server when said requested data does not correspond to said cached data.

16. A computer readable medium having computer executable instructions as set form in claim 15, performing a method further comprising:
caching at least a portion of said new data.

17. A computer readable medium having computer executable instructions as set form in claim 15, performing a method further comprising:
archiving said cached data.

18. A computer readable medium having computer executable instructions as set form in claim 17, performing a method further comprising:
retrieving said archived data as cached data.

19. A computer readable medium having computer executable instructions as set form in claim 15, wherein the client application is a web browser or an email client.

20. A computer readable medium having computer executable instructions as set forth in claim 15, wherein the server is a web server or email server.

21. A computer readable medium having computer executable instructions as set form in claim 13, wherein the cached data is made available by rendering said cached data.
